(19) United States
(12) Patent Application Publication
(10) Pub. No.: US 2008/0027882 A1
(43) Pub. Date: Jan. 31, 2008

(54) Price assessment method for used equipment

(76) Inventors: Robert Allen, Franklin, TN (US); Paul Knollmaier, Vesenaz (CH)

Correspondence Address: CATERPILLAR/FINNEGAN, HENDERSON, L.L.P., 901 New York Avenue, NW, WASHINGTON, DC, 20001-4413, US

(21) Appl. No.: 11/496,414

(22) Filed: Jul. 31, 2006

(51) Int. Cl. G06F 17/00

(52) U.S. Cl. 705/400

(57) ABSTRACT

A method is provided for pricing used equipment. The method may include automatically collecting data associated with used equipment from one or more data sources, wherein the data includes valuation data and classification data associated with the used equipment. The method may also include automatically operating on the data associated with the used equipment, storing the operated data in a storage system, and determining a machine price based on the valuation data and classification data associated with the used equipment stored in the storage system.

### TECHNICAL FIELD

This disclosure relates generally to a method for assessing a price and, more particularly, to a method for assessing a price of used equipment.

### BACKGROUND

A significant market for used equipment exists in some industries, such as, for example, construction, mining, or farming. Markets for used equipment are important where new equipment purchases are expensive or machine values slowly depreciate. High new equipment costs, shipping expenses, taxes, and/or long operational lifetimes can create sufficient demand to sustain viable markets for used equipment.

Traditionally, prices for used equipment can be determined based on previous sales data. Previous sales data including prices paid for similar machines can be collected over time periods sufficient to provide price estimations of reasonable accuracy. However, determining a reasonably accurate price for a used machine may be dependent upon numerous factors. For example, factors that may affect used equipment pricing can include depreciation, amount or type of prior use, geographical location, machine accessories, or component wear. Given the complexity and variability of the aforementioned factors, consistent and/or optimal pricing of used equipment has been difficult.

One method to determine prices of used vehicles is described in U.S. Publication No. 2005/0267774 (hereinafter “the '774 publication”) of Merritt et al., published on Dec. 1, 2005. The '774 publication describes a system for determining a vehicle price based on sales data obtained from various government agencies, such as, for example, the Department of Motor Vehicles, Department of Revenue, or Internal Revenue Service. The system may also use price data associated with a comparable vehicle or sales data obtained from other sources, such as list price, advertised price, or price that a dealer would sell an automobile. The system uses the sales data to determine a market value of a particular automobile.

While the system of the '774 publication may provide a vehicle valuation method, the system can be further improved. In particular, the system of the '774 publication may not be readily adapted to determine a price for used equipment. Used equipment price information may not be available from government agencies or other sources containing automobile price information. Further, used equipment pricing may be dependent upon additional factors unrelated to automobiles or automobile markets. For example, used equipment pricing may be highly dependent upon the location of a used machine, as transporting the machine to a purchaser may significantly increase the total cost of acquiring the machine.

The present disclosure is directed to overcoming one or more of the problems described above.

### SUMMARY OF THE INVENTION

One aspect of the present disclosure is directed toward a method for pricing used equipment. The method includes automatically collecting data associated with used equipment from one or more data sources, wherein the data includes valuation data and classification data associated with the used equipment. The method may also include automatically operating on the data associated with the used equipment, storing the operated data in a storage system, and determining a machine price based on the valuation data and classification data associated with the used equipment stored in the storage system.

Another aspect of the present disclosure is directed to a pricing system. The system includes a storage system and a central processing unit configured to automatically collect data associated with used equipment from one or more data sources, wherein the data includes valuation data and classification data associated with the used equipment. The central processing unit may be further configured to automatically operate on the data associated with the used equipment, store the operated data in the storage system, and determine a machine price based on the valuation data and classification data associated with the used equipment stored in the storage system.

### BRIEF DESCRIPTION OF THE DRAWINGS

The accompanying drawings, which are incorporated in and constitute a part of this specification, illustrate exemplary embodiments of the disclosure and, together with the written description, serve to explain the principles of the disclosed system. In the drawings:

FIG. 1 is a flow chart of an exemplary method for determining a used equipment price in accordance with the present disclosure.

FIG. 2 is a schematic illustration of an exemplary environment for performing the method of FIG. 1.

### DETAILED DESCRIPTION

In this disclosure, used equipment generally refers to any type of previously-owned machinery. In particular, used equipment may embody a stationary or mobile machine configured to perform some type of operation associated with an industry such as mining, construction, farming, manufacturing, transportation, power generation, or any other industry known in the art. For example, used equipment may include an earth moving machine such as a dozer, a loader, a backhoe, an excavator, a motor grader, or any other earth moving machine. Used equipment may, alternatively, embody a stationary generator set, pumping mechanism, or any other suitable operation-performing machine.

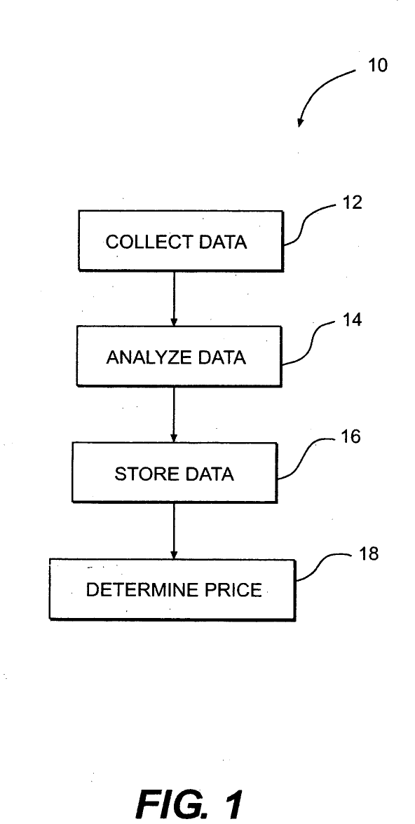

FIG. 1 illustrates an exemplary method 10 for pricing used equipment. Method 10 may include collecting data (Step 12), wherein the data may include any information associated with one or more used machines. In some embodiments, method 10 may include an analysis step (Step 14), wherein data collected by Step 12 may be reviewed for consistency and modified if necessary. Method 10 may also include storing data (Step 16), and may include determining a machine price of one or more used machines (Step 18), wherein the machine price may include a retail price, an auction price, or a wholesale price. It is also contemplated that method 10 may include additional, fewer, and/or different steps than those listed above. The steps of method 10 are not restricted to the order shown in FIG. 1. For example, data may be analyzed following storage of the data.

Collecting data, as indicated at Step 12, can include any automated process whereby data associated with one or more used machines is gathered. For example, an automated process may include an executable program, an algorithm, or other suitable software configured to search for and/or retrieve information from one or more sources of information.

Data associated with used equipment may be automatically collected from one or more data sources. Data sources may include any source of information related to one or more used machines. For example, data sources may include private or public databases, internet sites, or various other sources of information. Data sources may include information from used machine dealerships, machine manufacturers, or any sellers of used equipment. In some embodiments, software may be designed to automatically access and retrieve any suitable information contained within one or more data sources.

Data associated with used equipment may include any information suitable to determine a machine price of used equipment. In some embodiments, the data may include valuation data. Valuation data may include any historical data representing an amount of currency, or currency equivalent, designated to the used machine. The value of a used machine may be dependent upon machine type, model, age, accessories, rate of depreciation, machine condition, average purchase cost, maintenance costs, historical reliability factors, or any other factors that could be used to objectively determine a value of the used machine. In contrast, a machine price may be calculated based on any valuation data, as described in detail below. For example, determining a machine price may include assessment of additional factors affecting the value of a used machine, such as, geographic location, or market conditions.

Valuation data may include any form of monetary or capital measurement applied to a used machine or a portion of a used machine. For example, valuation data may include a retail price, a wholesale price, an auction price, a trade-in price, a lease value, a residual value, or any other suitable monetary measurement. Residual value may refer to an amount a business entity expects to be able to sell a piece of equipment at the end of a lease term or specified time limit. Therefore, a residual value may be dependent on a future value of a used machine.

Data associated with used equipment may also include any classification data of the used equipment. Appropriate classification of used machines may permit efficient organization of data of comparable used machines. Data may be organized by one or more classifications such that data associated with comparable machines may be readily accessed.

Classification data may include any suitable categorization information, such as, for example, a serial number, a production year, an equipment type, an equipment manufacturer, or an equipment model. Equipment type may refer to any type of used machine, such as, for example, a tractor, a dozer, a generator, or a portable crushing plant. Equipment model may refer to any identification information designated by the equipment manufacturer or used in an industry.

In some embodiments, data associated with used equipment may pertain to a component of the used equipment. A component may include any part and/or collection of parts associated with the used equipment that may affect a price of the used equipment. For example, a component may include an engine, a drive train, a hydraulic pump, an excavation bucket, a grading blade, or any part or parts of the used equipment. A value of used equipment can be dependent upon the quality of one or more components, as component replacement costs may be high, and the component's condition may significantly impact an operation or function of the used equipment.

Data associated with used equipment may further include condition information representing a condition of the used equipment. In some embodiments, condition information may include a ranking, such as, for example, excellent, very good, good, average, or poor. Condition information may pertain to the entire used machine, a portion of the used machine, and/or one or more components of the used machine. Also, condition information may represent a status, such as, for example, reconditioned, replaced, new, or worn. Condition data may include inspection reports, or other documents describing objective or subjective ratings associated with the used equipment.

In some embodiments, data associated with used equipment may also include a utilization index. The utilization index may include any data related to a use of a used machine, such as, for example, a time of operation or a type of use. For example, utilization index may include the number of hours an engine has been operating, the number of miles a machine has traveled, or any other suitable representation of machine use.

Data associated with a specific used machine may be collected from one or more data sources. For example, a first data source may include used machine valuation data and a second data source may include component information for the used machine. Data from the first and second data sources may be collected and combined to provide sufficient information to determine a machine price of the used machine.

Analyzing data, as shown at Step 14, may include one or more automated processes to operate on the data collected by Step 12. For example, the collected data may include information in various formats, as different data sources may utilize different data formats. Equipment descriptions may be written in a non-English language, measurement data may be represented by metric or imperial units, or equipment descriptors may vary regionally. In some embodiments, the collected data may be automatically operated on to at least partially standardize the data associated with one or more used machines.

In some embodiments, operating on data may include any process designed to standardize any data required to calculate a machine price of used equipment. For example, operating on data can include currency conversion, expanding a text abbreviation, reformatting data, removing spurious data, eliminating duplicate records describing the same used machine, and/or any other suitable process. Operating on data may include artificial intelligence, fuzzy logic, or any other methods configured to recognize key words, abbreviations, or other text. In some situations, it may be determined that no data modification is required. For example, equipment descriptors contained in data gathered from different sources may be identical.

Storing data, as shown at Step 16, may include storing any data associated with one or more used machines. Data storage may include storing data using any hardware and/or software known in the art, as described in detail below. In some embodiments, data may be stored in one or more databases. It is contemplated that, as data is collected and stored, the accuracy of calculating a machine price of a used equipment will improve due to increased availability of relevant data.

Data may be stored in any suitable format. For example, data may be stored based on used equipment classification data as previously described. Such data storage may permit efficient comparison of similar types of machines, machines with similar quality components, machines of similar age, and/or machines from similar geographical locations.

Determining a price, as shown in Step 18, may include calculating a machine price of a used machine. A machine price may include any suitable monetary measurement of a used machine, such as, for example, a retail price, a wholesale price, an auction price, a trade-in price, a lease value, or a residual value. The machine price may be calculated based on any valuation data and classification data, such as, for example, machine type, model, or components. In some embodiments, a machine price may be calculated based on one or more pricing factors, such as, for example, a geographic location, or a local market condition.

A machine price may be determined based on any used equipment data collected, operated on, and stored using method 10. In some embodiments, one or more different types of machine prices may be determined. For example, a retail price of a used machine may be determined based on a wholesale price of the used machine. Retail prices may approximately correlate with wholesale prices, wherein retail prices may be 10% higher than wholesale prices. Therefore, a machine retail price of the used machine may be determined by increasing a wholesale price of the used machine by 10%.

In some embodiments, Step 18 may include calculating a machine price based on data associated with one or more comparable used machines, wherein the machine price of a used machine may be determined based on different and/or similar features of comparable machines. For example, Machine A of unknown value may be compared to Machine B of known value, wherein Machine A and Machine B are similar. Machine A may include a component that constitutes 20% of the value of Machine A. Machine B may include a component similar to the component of Machine A. Based on the known value of Machine B, 20% of the machine price of Machine A may be determined based on 20% of the value of Machine B. Such differences and/or similarities between comparable machines may be weighed differently depending upon the available valuation data and classification data of the used machines.

In some embodiments, the machine price may include a discount or premium added to a used machine value. The discount or premium may include assessment of one or more pricing factors affecting the value of a used machine. For example, pricing factors may include a type of use, a geographic location, a market condition, a transaction condition, a quantity of used machines, or a subjective factor.

Previous machine use may affect a machine price determination. Type of use may describe any form of machine use, such as, for example, operation in a highly corrosive mine site, specific farming application, or type of construction use. Such information may impact a machine price determination as equipment used for harsh or high work load applications may depreciate more quickly than equipment used for mild or low work load applications.

Geographic location may also impact a machine price calculation, wherein geographic location may include, a country, a region, a state, a city, or a street. For example, Machine A of unknown value may be compared to Machine C of known value and similar type to Machine A. Machine A and Machine C may be both located within a common geographic location, and geographic location may affect machine value by 10% based on historical data. Therefore, 10% of a machine price of Machine A may be determined based on 10% of the value of Machine C. Such information may impact a machine price calculation as equipment may depreciate more quickly in a cold, wet climate as opposed to a dry, arid climate.

In some embodiments, fluctuations in local market conditions may impact a machine price determination as used equipment sales are generally low volume. For example, a large building project may increase local demand for earth moving equipment, while a mine closure may flood a local market with used mining equipment. In addition, local market conditions may impact different types of valuations differently. For example, retail prices may be 20% higher than wholesale prices in markets where demand exceeds supply and manufacturers are slow to respond to local market conditions. In contrast, the difference between retail and wholesale prices may be 5% in markets where demand approximately matches supply. Such market conditions may affect short-term or long-term used equipment valuations, and hence any machine price calculation dependent upon such data.

Machine price determination may also be dependent on a transaction condition, wherein a transaction condition may include a specific detail of a financial transaction involving the used equipment. For example, machine price determination may be dependent upon the number of machines in a transaction. A machine price calculated for a used machine may be different for a transaction involving a single used machine as compared to a transaction involving multiple machines. Multiple machines may be priced to incorporate a bulk purchase discount, and pricing a fleet of used machines may include determining multiple machine prices, such as, for example, retail prices for some machines and lease values for other machines. A transaction condition may also include a currency exchange rate, an interest rate, or any other suitable financial factor that may affect a present or future value of a used machine.

Machine price determination may also be dependent upon one or more subjective factors. Subjective factors may include factors affecting a particular buyer, seller, or other party involved in a transaction including a used machine. Subjective factors may include assessment of a historical relationship between transacting parties, goodwill, or any other factor that may affect the optimum price of a machine. For example, a buyer may calculate an optimum price, yet may further reduce an expected purchase price due to predicted increased availability of competing new machines. Conversely, a seller may calculate an optimum price and reduce it further in order to expedite a sale.

In some embodiments, a machine price may be determined using one or more suitable mathematical techniques, such as, for example, filtering, regression analysis, statistical methods, probabilistic methods, or any appropriate algorithm. For example, if a machine price of a specific machine is much lower or much higher than similar machines, the specific machine price may be excluded from any price assessment. Such filtering, or other suitable techniques, may be applied to remove any spurious data from a machine price determination. In some embodiments, various filtering or other mathematical techniques may be applied to data during any data analysis, as previously described in Step 14.

Machine pricing of used equipment may be dependent upon the quantity and/or quality of stored data associated with used machines. Larger quantities of organized data associated with a used machine may permit more accurate machine price calculations than lesser quantities of similar data. For example, a machine price based on extensive data representing machine components may be more accurate than a machine price based on limited data representing machine components, wherein the extensive data may include detailed condition, utilization, and/or location information. In addition, determining a machine price of used equipment may depend on the data accuracy, availability of comparable data, or number of data points. For example, highly variable, unrelated, or sparse data may result in less accurate machine price determinations, while consistent, related, or numerous data may result in more accurate machine price determinations. As such, a machine price of used equipment may include a measure of average price, standard deviation, or other type of error range or indicator of price variability.

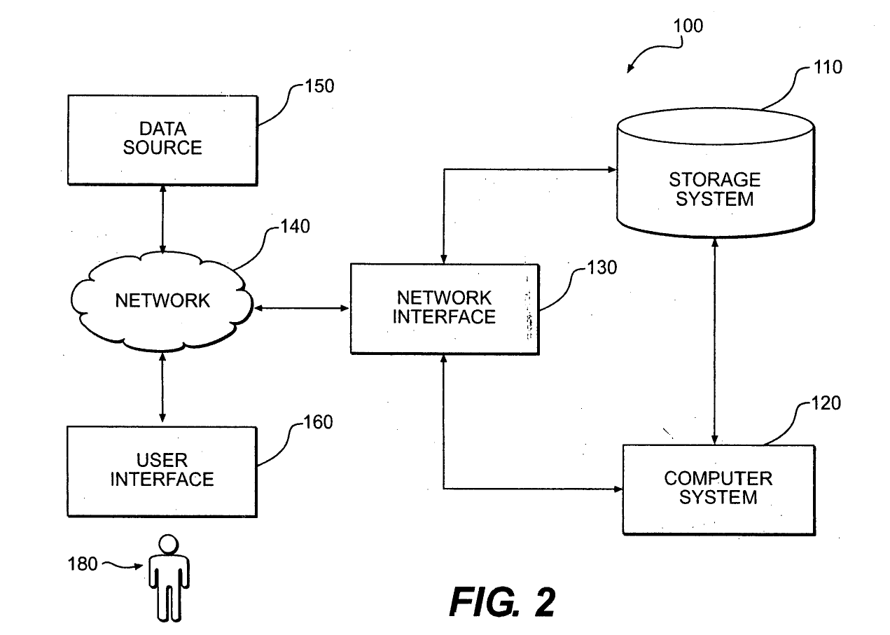

FIG. 2 is a schematic illustration of an exemplary environment 100 for performing method 10. Used equipment pricing (UEP) environment 100 may include a storage system 110, a computer system 120, and a network interface 130. Network interface 130 may be operably connected to a network 140, one or more data sources 150, and/or one or more user interfaces 160. Network interface 130 may also be configured to permit communication between network 140, storage system 110, data source 150, user interface 160 and/or computer system 120. In some embodiments, computer system 120 may be operably connected to storage system 110. UEP environment 100 may include additional, fewer, and/or different components than those listed above. It is understood that the type and number of listed devices are exemplary only and not intended to be limiting.

Storage system 110 may include any appropriate type of storage device and/or hardware configured to store data. For example, storage system 110 may include one or more hard disk devices, optical disk devices, tape drives, or other storage devices to provide any required data storage. It is also contemplated that storage system 110 may include a random access memory (RAM) or a read-only memory (ROM). In addition, UEP environment 100 may include one or more storage systems 110.

Storage system 110 may include any software configured to permit storage of any data associated with used equipment. As previously described, data associated with one or more used machines may include data representative of valuation data, classification data, component data, or condition data of one or more used machines. In some embodiments, storage system 110 may include a database configured to store any data associated with UEP environment 100, wherein the database may include a relational, distributed, or any other suitable database format.

Computer system 120 may include any hardware and/or software configured to perform an operation within UEP environment 100. Specifically, computer system 120 may include hardware and/or software executed by a processor (not shown). The processor may include any appropriate type of general purpose microprocessor, digital signal processor, or microcontroller. The processor may execute one or more sequences of computer code to perform various processes associated with UEP environment 100 and/or method 10.

Computer system 120 may also include a memory (not shown), and an input device (not shown). In some embodiments, computer code may be loaded into the memory for execution by the processor. The memory may include any appropriate type of storage provided to store any type of information that the processor may need to perform any process. For example, the memory may include one or more RAM, ROM, hard disk devices, optical disk devices, or other storage devices. In addition, computer system 120 may include one or more input devices, such as, for example, a keyboard (not shown), or a mouse (not shown) configured to input data into computer system 120. For example, data associated with one or more used machines may be input into storage system 110 using one or more input devices.

Computer system 120 may include any computer code configured to perform one or more sub-routines and/or algorithms to determine one or more machine prices of one or more used machines. Specifically, computer system 120 may include any software configured to perform method 10. Computer system 120 may perform one or more computational processes to at least partially collect, analyze and/or store any data associated with used equipment, as previously described.

Additional hardware and/or software may also be required to operate computer system 120, such as, for example, security applications, authentication systems, dedicated communication systems, etc. The hardware and/or software may be interconnected and accessed as required by authorized users. In addition, a portion, or all of, computer system 120 may be hosted and/or operated by a third party. Further, computer system 120 may be operably connected to network interface 130.

Network interface 130 may include any hardware and/or software configured to permit communication between one or more components of UEP environment 100. For example, network interface 130 may include any type of web server and/or application server software configured to operate various communication protocols, such as, for example transmission control protocol/internet protocol (TCP/IP), or hyper text transfer protocol (HTTP). In particular, network interface 130 may be operably connected to network 140 such that user interface 160 may access computer system 120 and/or storage system 110. Network interface 130 may also provide communication connections such that computer system 120 may access one or more data sources 150 via network 140.

Network 140 may include any type of communication system capable of transferring data, such as, for example, the Internet, an intranet, an extranet, or a local area network (LAN). Network 140 may include any communication system that uses any type of signal to transmit and/or receive data. Further, network 140 may be operably connected to one or more data sources 150 and/or user interfaces 160.

Data sources 150 may include any data associated with used equipment, such as, for example, classification data, valuation data, component, data, and/or utilization data. Further, data sources 150 may include any collection of sources accessible via network 140, such as, for example, internet sites, public databases, or private databases. For example, data sources 150 may include various internet sites listing used machine price information, such as, newspapers, and sites dedicated to construction equipment, farming equipment, mining equipment, or other internet sites. These internet sites may also list a geographic location of the used machine, components included on the machine, condition of the machine, and any other data as previously described. In some embodiments, computer system 120 may be configured to collect data associated with one or more used machines from one or more data sources 150.

User interface 160 may include any electronic device and/or software configured to permit a user 180 to interact with one or more components of UEP environment 100. For example, user interface 160 may visually display any appropriate data associated with one or more used machines to user 180. In addition, user interface 160 may be configured to display one or more machine prices determined using method 10. It is contemplated that user interface 160 may display a plurality of numbers, text, graphics, and/or any other indicia.

In some embodiments, user interface 160 may include any suitable interface configured to permit user 180 to access storage system 110 and/or computer system 120. For example, user 180 may want to access data associated with used equipment to determine a machine price of used equipment. Computer system 120 may receive a request from user 180 to access data stored in storage system 110. Computer system 120 may then access data records stored in storage system 110. The relevant data may then be transmitted via network interface 130 and network 140 such that the data may be displayed on user interface 160. The data may then be used to determine a machine price as previously described.

### INDUSTRIAL APPLICABILITY

The present disclosure provides a system and method for determining a machine price of a used machine. In particular, the disclosed system and method may be used to determine a machine price of one or more used machines, or one or more different types of machine prices of a used machine. The disclosed system and method may improve the accuracy of pricing used equipment, and thus provide improved financial assessment of used equipment.

Traditionally, systems and methods for pricing used equipment have had limited accuracy. Reliable data was often difficult to obtain, as different used equipment distribution centers utilized different information formats. While one market may use certain language or descriptors to describe a used machine, another market may use significantly different language or descriptors, making comparison between similar machines difficult across markets. In addition, traditional markets often lack sufficiently detailed information required to determine machine prices. Often condition or utilization data for used equipment was consistent only within a single market, or such data was not available. Further, the data was often poorly organized so that efficient data analysis was problematic. The present disclosure improves on existing methods in several ways.

The present system and method may permit automatic data collection from multiple data sources, thereby increasing the quantity of data gathered and data available for analysis. In some embodiments, the system may automatically gather information from disparate sources using one or more software programs to periodically search publicly available data to retrieve valuation data and other used equipment information. Such automated processes may permit fast and efficient collection of large amounts of pertinent data.

Following data collection, the data may be analyzed to determine if any data operations are required. Operating on data may include a range of automated processes to “clean,” or at least partially standardize any relevant data. In some embodiments, operating on data may include removal of duplicate data records gathered from different sources, text conversion of non-standard descriptors, reformatting data, reclassification of data, or any other suitable alteration of any collected data. Data gathered from various different sources may be standardized, classified and/or stored, as previously described. Such data may permit faster data access and/or more accurate used machine pricing.

Storing the cleaned data within a single system may offer several advantages. For example, large amounts of data may be distributed throughout a number of operably connected storage systems. Such systems may permit increased numbers of users more efficient access to review used equipment information. Time may be saved by providing a single source of consistent and uniformly classified data configured to permit detailed data analysis and/or machine price determination. Also, improved data and improved data accessibility may permit improved financial analysis of used machine pricing, providing more accurate price estimations and better price prediction methods.

The system and method of the present disclosure may also permit enhanced machine price assessment of used machines. As outlined above, advantages may be gained by having a single source of collated and cleaned data. Such data may include more recent data gathered from a larger number of sources and representing more detailed information than data associated with traditional systems. Improved data quality and/or quantity may permit more accurate calculation of a machine price, as the stored data may include more detailed information. For example, the present disclosure may include used equipment data associated with multiple cities or states, rather than country-wide data. Such localized data may permit pricing reflective of regional differences in used equipment values, rather than limiting pricing to nation-wide, average values. Data including detailed records pertaining to used equipment components, utilization, and/or other machine features may similarly be utilized to accurately determine a machine price based on any number of factors that affect used equipment values. It is also contemplated that the present system can improve pricing accuracy over time by gathering information and tracking price trends for longer time periods.

It will be apparent to those skilled in the art that various modifications and variations can be made to the disclosed system for used equipment pricing. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A method for pricing used equipment, comprising:
automatically collecting data associated with used equipment from one or more data sources, wherein the data includes valuation data and classification data associated with the used equipment;
automatically operating on the data associated with the used equipment;
storing the operated data in a storage system; and
determining a machine price based on the valuation data and classification data associated with the used equipment stored in the storage system.

2. The method of claim 1, wherein the valuation data includes at least one of a retail price, a wholesale price, an auction price, a trade-in price, a lease value, or a residual value.

3. The method of claim 1, wherein the classification data includes at least one of a serial number, a production year, an equipment type, an equipment manufacturer, and an equipment model.

4. The method of claim 1, wherein the data associated with the used equipment further includes data representative of at least one of a component of the used equipment, and a utilization index associated with the used equipment.

5. The method of claim 4, wherein the utilization index includes data representative of at least one of an operational time or a type of machine use.

6. The method of claim 1, wherein operating on the data includes at least one process selected from the group consisting of removing duplicate data, removing spurious data, and reformatting data.

7. The method of claim 1, wherein the machine price includes at least one of a retail price, a wholesale price, an auction price, a trade-in price, a lease value, or a residual value.

8. The method of claim 1, wherein determining the machine price further includes adding at least one of a discount or a premium.

9. The method of claim 8, wherein the discount or the premium are based on at least one of a type of use, a geographic location, a market condition, a transaction condition, or a subjective factor.

10. The method of claim 1, wherein determining the machine price includes at least one of determining one or more prices of the used equipment or determining a price of one or more used machines.

11. A pricing system, comprising:
a storage system; and
a central processing unit configured to:
automatically collect data associated with used equipment from one or more data sources, wherein the data includes valuation data and classification data associated with the used equipment;
automatically operate on the data associated with the used equipment;
store the operated data in the storage system; and
determine a machine price based on the valuation data and classification data associated with the used equipment stored in the storage system.

12. The pricing system of claim 11, wherein the valuation data includes at least one of a retail price, a wholesale price, an auction price, a trade-in price, a lease value, or a residual value.

13. The pricing system of claim 11, wherein the classification data includes at least one of a serial number, a production year, an equipment type, an equipment manufacturer, and an equipment model.

14. The pricing system of claim 11, wherein the data associated with the used equipment further includes data representative of at least one of a component of the used equipment, and a utilization index associated with the used equipment.

15. The pricing system of claim 14, wherein the utilization index includes data representative of at least one of an operational time or a type of machine use.

16. The pricing system of claim 11, wherein operating on the data includes at least one process selected from the group consisting of removing duplicate data, removing spurious data, and reformatting data.

17. The pricing system of claim 11, wherein the machine price includes at least one of a retail price, a wholesale price, an auction price, a trade-in price, a lease value, or a residual value.

18. The pricing system of claim 11, wherein determining the machine price further includes adding at least one of a discount or a premium.

19. The pricing system of claim 18, wherein the discount or the premium are based on at least one of a type of use, a geographic location, a market condition, a transaction condition, or a subjective factor.

20. The pricing system of claim 11, wherein determining the machine price includes at least one of determining one or more prices of the used equipment or determining a price of one or more used machines.
